(19) United States
(12) Patent Application Publication
(10) Pub. No.: US 2006/0089108 A1
(43) Pub. Date: Apr. 27, 2006

(54) Mechanical latch including RF antenna

(76) Inventors: Isaac Lagnado, Houston, TX (US); Timothy Neill, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/974,382

(22) Filed: Oct. 26, 2004

(51) Int. Cl. H04B 1/38

(52) U.S. Cl. 455/90.3

(57) ABSTRACT

A portable electronic device, including a base mechanically coupled to a display enclosure with a hinge, is built including latches on the display enclosure configured to mechanically lock the display enclosure to the base when the display is closed. The latches are permanently coupled to the display enclosure and are electrically coupled to a wireless network circuit in such a manner as to act as an RF antenna for the wireless network.

### FIELD OF THE INVENTION

The present invention relates generally to the field of wireless networks and more specifically to RF antennas for use in wireless networks.

### BACKGROUND OF THE INVENTION

As wireless networks become more and more common, many mobile computing devices are incorporating network hardware within the portable computer. Signal integrity correlates to network speed so designers work to provide effective RF antennas within portable electronic devices in such ways that signal integrity is maximized. Prior solutions include the use of external RF antennas that electrically couple to the portable device, or the placement of RF antennas within a display enclosure. External RF antennas require the portable device to provide an external RF antenna connector, taking up valuable space on the exterior of the enclosure. Also, external RF antennas are vulnerable to damage since they are typically attached along one of the sides of the enclosure where they may inadvertently be bumped or otherwise impacted. Placement of RF antennas within a display enclosure, particularly for laptop computers, solves some of the problems inherent in external RF antennas, but also results in other difficulties. For example, by placing an RF antenna within a display enclosure, the antenna is limited in size by spacing constraints between the enclosure and display itself, there is possible degradation of the signal integrity due to the presence of display hardware in close proximity to the antenna, and the antenna may be subject to damage during installation.

### SUMMARY OF THE INVENTION

A portable electronic device, including a base mechanically coupled to a display enclosure with a hinge, is built including latches on the display enclosure configured to mechanically lock the display enclosure to the base when the display is closed. The latches are permanently coupled to the display enclosure and are electrically coupled to a wireless network circuit in such a manner as to act as an RF antenna for the wireless network.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a view of a portable electronic device including a body and a display enclosure according to the present invention.

FIG. 2 is a top view of a display enclosure including two latches configured to operate as RF antennas according to the present invention.

FIG. 3 is a front view of a display enclosure including two latches configured to operate as RF antennas according to the present invention.

FIG. 4 is a flowchart of a method for incorporating an RF antenna into a mechanical latch according to the present invention.

### DETAILED DESCRIPTION

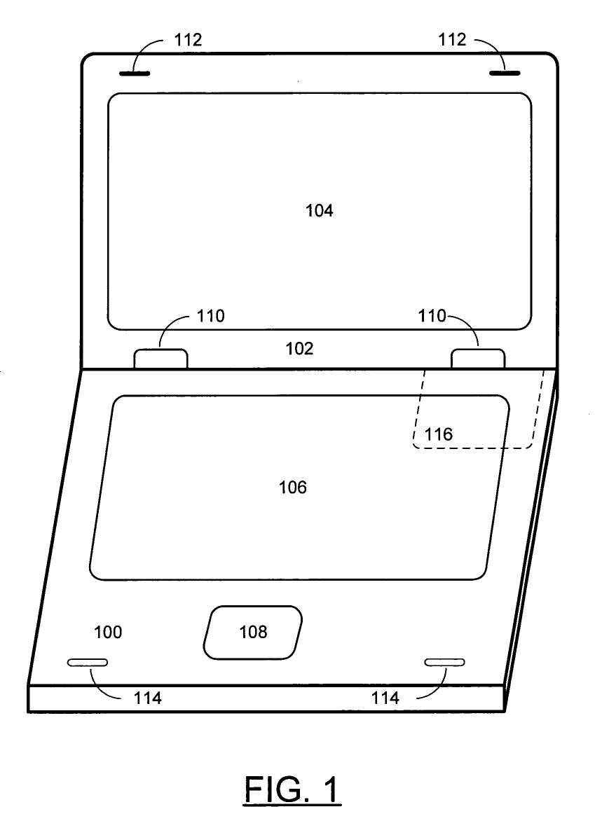

FIG. 1 is a view of a portable electronic device including a body and a display enclosure according to the present invention. In an example embodiment of the present invention, a portable electronic device including a body 100, and a display enclosure 102 is provided. Within the display enclosure 102 is a display 104. The body 100 includes a keyboard 106 and a touch pad 108. The display enclosure 102 is mechanically coupled to the body 100 by two hinges 110. When closed, the display enclosure 102 is locked to the body 100 by two latches 112 which lock into latch receptacles 114 within the body 100. Within the body 100 is a wireless network device 116 used to communicate with any available wireless network. The latches 112 are electrically coupled with this wireless network device 116 in such a manner that they operate as an RF antenna for the wireless network device 116. Those of skill in the art will recognize that the wireless network device 116 shown in this example embodiment of the present invention as residing in the body 100 of the portable electronic device may in other embodiments within the scope of the present invention, actually be located in other places, such as the display enclosure, or even external to the portable electronic device. Also, the latches 112 may be configured into a variety of antenna designs, such as PIFA (Planar Inverted F Antenna) or loop type, within the scope of the present invention. By configuring the latches 112 to act as one or more RF antennas for the wireless network device 116, several advantages to prior art solutions are obtained. First, when the display enclosure is opened from the body 100, the latches 112 are near the highest point of the portable electronic device resulting in improved reception of the wireless network signals. Also, improved antenna performance may be obtained since the antenna has more external area away from the display 104 than a solution incorporating the antenna within the display enclosure 102. Also, if desired external antenna extensions may be electrically and mechanically coupled to the latches 112 for even further improved antenna performance. Further, multiple latches may be used to provide diversity. A single latch may be used in conjunction with an on-board antenna to provide either diversity, or different frequency or polarization characteristics of the RF antenna.

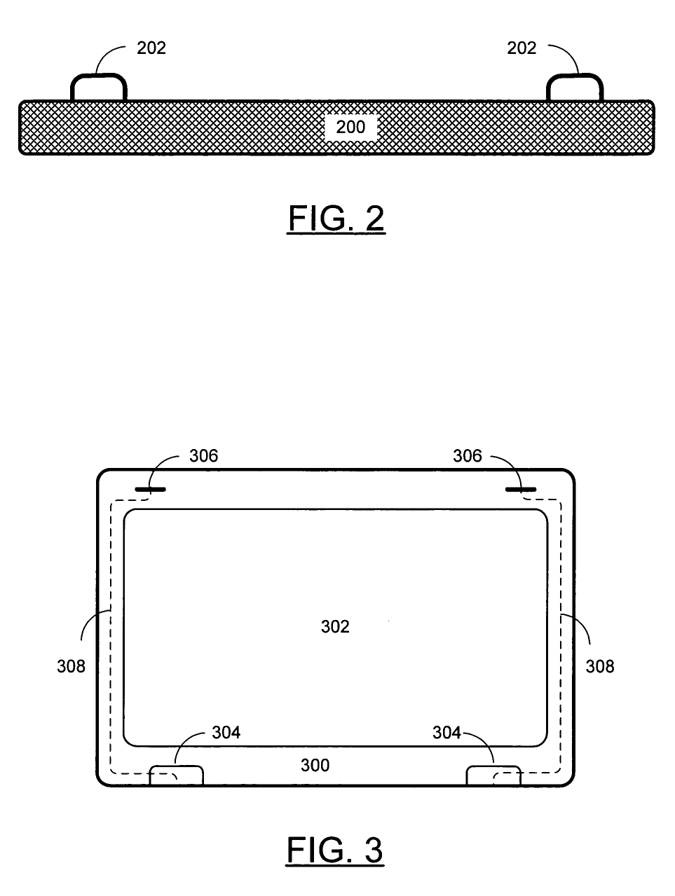

FIG. 2 is a top view of a display enclosure including two latches configured to operate as RF antennas according to the present invention. In a top view of the example embodiment of the present invention as shown in FIG. 1, a display enclosure 200 is provided including two latches 202. These latches 202 as shown in this example embodiment are two metal loops mechanically coupled to the display enclosure 200 and configured to couple with the latch receptacles 114 provided within the body 100 of the portable electronic device. These latches 202 are also electrically coupled with a wireless network device 116 in such a manner as to act as one or more RF antennas for the wireless network device 116. Those of skill in the art will recognize that many other latch shapes may be used within the scope of the present invention, and that these metal loops are simply an example embodiment of the present invention.

FIG. 3 is a front view of a display enclosure including two latches configured to operate as RF antennas according to the present invention. In this example embodiment of the present invention, a display enclosure 300 similar to that of FIGS. 1 and 2 is provided including a display 302, hinges 304, and two latches 306. The two latches 306 are configured to operate as RF antennas, and are electrically coupled with a wireless network device (not shown in this figure) through wires 308. Those of skill in the art will recognize that while this example embodiment of the present invention shows the latches 306 electrically coupling with a wireless network device through two wires running through the two hinges 304, many other methods may be used to electrically couple the latches 306 with a wireless network device.

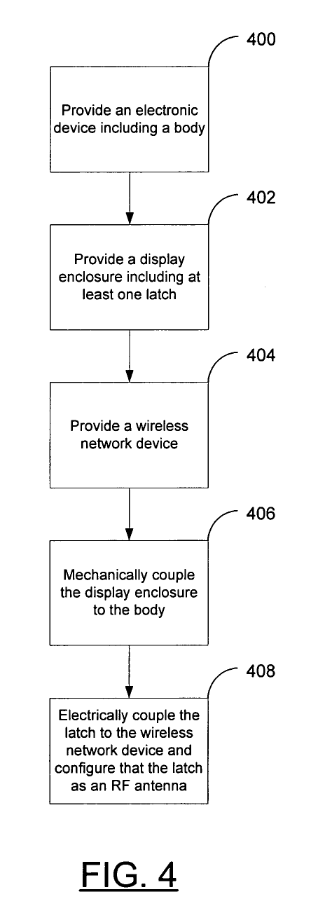

FIG. 4 is a flowchart of a method for incorporating an RF antenna into a mechanical latch according to the present invention. In a step 400, an electronic device including a body is provided. In a step 402, a display enclosure including at least one latch is provided. In a step 404, a wireless network device is provided. In a step 406, the display enclosure is mechanically coupled to the body. In a step 408, the latch is electrically coupled to the wireless network device and configured to act as an RF antenna for the wireless network device.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device comprising:
a body;
a wireless network device; and
a display enclosure mechanically coupled with said body, including at least one latch electrically coupled with said wireless network device; wherein said latch is configured to operate as an RF antenna for said wireless network device.

2. A device as recited in claim 1,
wherein said display enclosure is mechanically coupled with said body by one or more hinges.

3. A device as recited in claim 2,
wherein said wireless network device is enclosed within said body; and
wherein said at least one latch is electrically coupled with said wireless network device through said one or more hinges.

4. A device as recited in claim 1,
wherein said body includes at least one latch receptacle, and
wherein said at least one latch is configured to mechanically couple with said at least one latch receptacle when said display enclosure is closed.

5. A device as recited in claim 1,
wherein said body includes a keyboard.

6. A device as recited in claim 1,
wherein body includes a touch pad.

7. A device as recited in claim 1,
wherein said display enclosure includes a display.

8. A device as recited in claim 1,
wherein said latches form a PIFA antenna.

9. A device as recited in claim 1,
wherein said latches form a loop type antenna.

10. A method for incorporating an RF antenna into a latch, comprising the steps of:
a) providing an electronic device including a body;
b) providing a display enclosure including at least one latch;
c) providing a wireless network device;
d) mechanically coupling the display enclosure to the body;
e) electrically coupling the at least one latch to the wireless network device;
f) configuring the at least one latch as an RF antenna for the wireless network device.

11. A method as recited in claim 10:
wherein the display enclosure is mechanically coupled to the body by one or more hinges.

12. A method as recited in claim 10:
wherein the wireless network device is enclosed within the body; and
wherein the at least one latch is electrically coupled with the wireless network device through the one or more hinges

13. A device as recited in claim 10:
wherein the body includes at least one latch receptacle, and
wherein the at least one latch is configured to mechanically couple with the at least one latch receptacle when the display enclosure is closed.

14. A method as recited in claim 10:
wherein the body includes a keyboard.

15. A method as recited in claim 10:
wherein the body includes a touch pad.

16. A method as recited in claim 10:
wherein the display enclosure includes a display.

17. A method as recited in claim 10:
wherein the latches form a PIFA antenna.

18. A method as recited in claim 10:
wherein the latches form a loop type antenna.
